(19) United States
(12) Patent Application Publication
(10) Pub. No.: US 2020/0396044 A1
(43) Pub. Date: Dec. 17, 2020

(54) METHOD FOR SWITCHING A BANDWIDTH PART (BWP) FOR CONFIGURED UL RESOURCES IN WIRELESS COMMUNICATION SYSTEM AND A DEVICE THEREFOR

(71) Applicant: LG ELECTRONICS INC., Seoul (KR)

(72) Inventors: Eunjong LEE, Seoul (KR); Sunyoung LEE, Seoul (KR)

(73) Assignee: LG ELECTRONICS INC., Seoul (KR)

(21) Appl. No.: 16/958,145

(22) PCT Filed: Nov. 8, 2018
(86) PCT No.: PCT/KR2018/013531

§ 371 Date: Jun. 25, 2020

Related U.S. Application Data
(60) Provisional application No. 62/611,478, filed on Dec. 28, 2017.

(51) Int. Cl. H04L 5/00; H04W 72/04; H04W 74/08; H04W 28/02; H04W 72/14

(52) U.S. Cl. CPC H04L 5/0092; H04L 5/0098; H04W 72/0413; H04W 72/14; H04W 74/0833; H04W 28/0278; H04W 72/0453

(57) ABSTRACT

The present invention relates to a wireless communication system. More specifically, the present invention relates to a method and a device for switching a Bandwidth part (BWP) for configured UL resources in wireless communication system, the method comprising: checking whether or not there are available uplink (UL) resources on an active Bandwidth Part (BWP), when the UE has UL data to be transmitted; checking whether or not there are UL resources on inactive BWPs, if there is no available UL resource to transmit the UL data in the active BWP; selecting a BWP among the inactive BWPs which have UL resources allowed to transmit the UL data; activating the selected BWP; and transmitting the UL data using the UL resource on the selected BWP.

### TECHNICAL FIELD

The present invention relates to a wireless communication system and, more particularly, to a method for switching a Bandwidth part (BWP) for configured UL resources in wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication (NR, New Radio). In addition, a communication system design considering a service/UE sensitive to reliability and latency is being discussed. The introduction of next-generation RAT, which takes into account such Enhanced Mobile BroadBand (eMBB) transmission, and ultra-reliable and low latency communication (URLLC) transmission, is being discussed.

### DISCLOSURE

### Technical Problem

An object of the present invention devised to solve the problem lies in a method and device for switching a Bandwidth part (BWP) for configured UL resources in wireless communication system.

In NR, the maximum channel bandwidth can be 400 MHz per carrier. Operating the wider bandwidth on a single carrier is more efficient than aggregating contiguous intra-band CCs with smaller bandwidth. In order to provide the carrier with maximum bandwidth for UEs with different RF chain capabilities, RAN1 agreed to support the aggregation of multiple sub-bands with smaller bandwidth. In this wider bandwidth operation, it assumes that one or multiple bandwidth part (BWP) configurations for each CC can be semi-statically signalled to a UE and each bandwidth part is associated with a specific numerology.

According to the current specification, there can be configured UL resources on an inactive BWP of a UE, e.g., configured SR PUCCH, suspended Configured Grant (CG) Type 1 or PRACH. These resources can be configured per BWP of a UE, and it is considered valid only while the BWP is active.

For UL SPS, RAN2 agreed to use CG Type 1 and Configured Grant (CG) Type 2. CG Type 1 resource is activated upon RRC configuration according to resource allocation in terms of periodicity and offset provided within the configuration, and it is released by RRC. The MAC entity shall clear the configured uplink resource assignments for CG type 1 immediately when receiving RRC reconfiguration message of CG Type 1 release. However, the CG type 1 resource of the deactivated BWP/SCell is suspended when the BWP or SCell is deactivated. From the MAC point of view, the suspended CG type 1 resource is not deactivated (i.e., not clear), but is considered as invalid resource due to the deactive BWP/SCell. Upon SCell/BWP activation the UE starts using the CG type 1 resources of the active SCell/BWP.

In NR, the MAC entity may be configured with zero, one, or more SR configurations. Each SR configuration corresponds to one or more logical channels. If UE have SR configurations but a mapping is not configured for a LCH assigned to a LCG, a RACH is triggered.

For the SR, at most one PUCCH resource for SR is configured per BWP, and only PUCCH resources on an active BWP at the time of SR transmission occasion are considered valid. When the BWP is deactivated, the SR configuration is kept but is not valid. The configured SR PUCCH and suspended CG type1 resources on the inactive BWP are considered valid upon the BWP is activated without an explicit signaling of gNB.

Currently, the UE cannot switch itself to another UL BWP without explicit/implicit indication of the gNB or timer expiry, except for switching to the initial DL/UL BWP for CBRA. Moreover, the UE cannot activate itself the SCell without explicit signalling of the gNB.

In this case, there is a problem in that a Random Access procedure must be performed even though there is a UL resource available for other inactive BWPs, if there is no UL resource in the active BWP.

The technical problems solved by the present invention are not limited to the above technical problems and those skilled in the art may understand other technical problems from the following description.

### Technical Solution

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects

According to the present invention, if there is no available UL resources on the active BWP or SCell, the UE can switch to (or activates) the UL BWP or SCell with the configured UL resources, so that the UE uses the configured UL resources, e.g., PUSCH, PUCCH, etc., on the inactive UL BWP/SCell without performing unnecessary RA procedures.

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2a is a block diagram illustrating network structure of an evolved universal mobile telecommunication system (E-UMTS), and FIG. 2b is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4a is a block diagram illustrating network structure of NG Radio Access Network (NG-RAN) architecture, and FIG. 4b is a block diagram depicting architecture of functional Split between NG-RAN and 5G Core Network (5GC);

FIG. 5 is a diagram showing a control plane and a user plane of a radio interface protocol between a UE and a NG-RAN based on a 3rd generation partnership project (3GPP) radio access network standard;

FIG. 6 is a block diagram of a communication apparatus according to an embodiment of the present invention;

FIG. 7 is an example for Bandwidth Part (BWP) operation in the prior art;

FIG. 8 is a conceptual diagram for switching a Bandwidth part (BWP) for configured UL resources by a user equipment in wireless communication system according to embodiments of the present invention; and

FIGS. 9 and 10 are examples for switching a Bandwidth part (BWP) for configured UL resources in wireless communication system according to embodiments of the present invention.

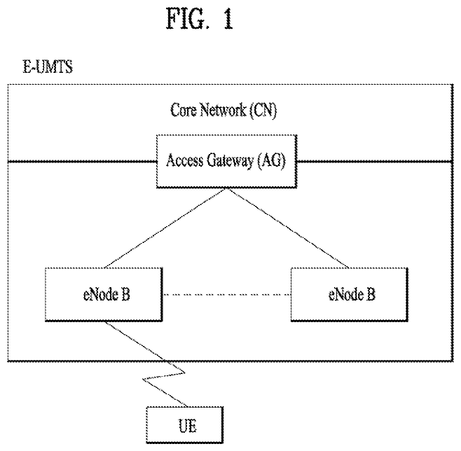

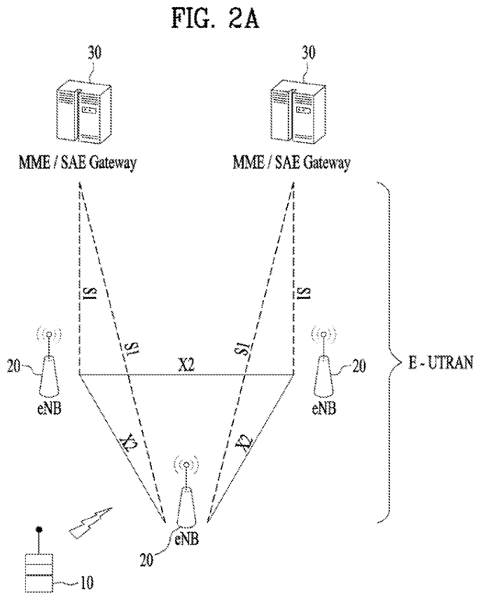

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (CPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

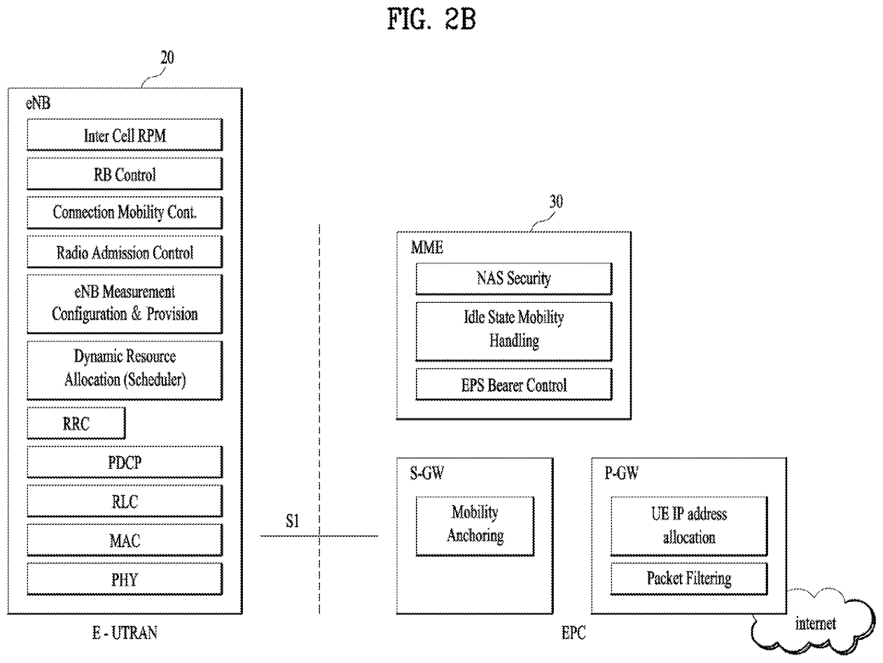

FIG. 2a is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2a, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2b is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

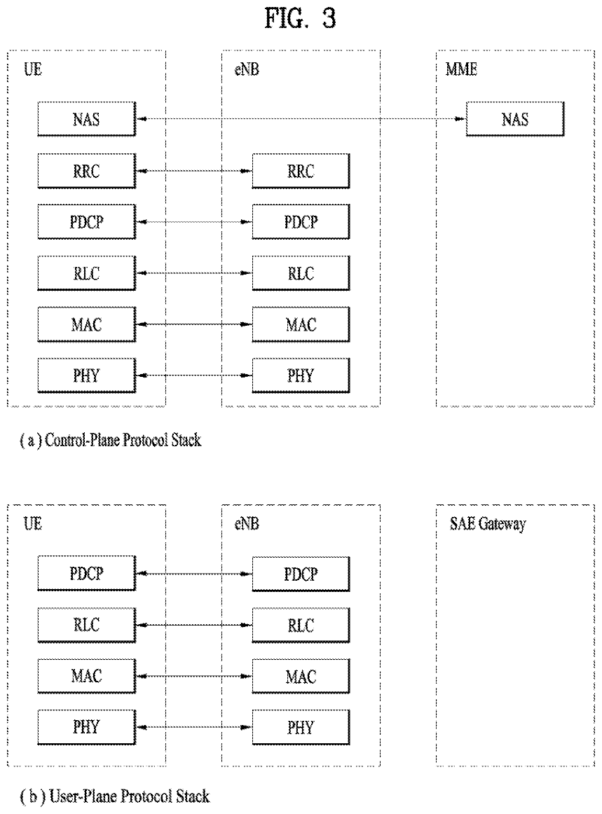

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

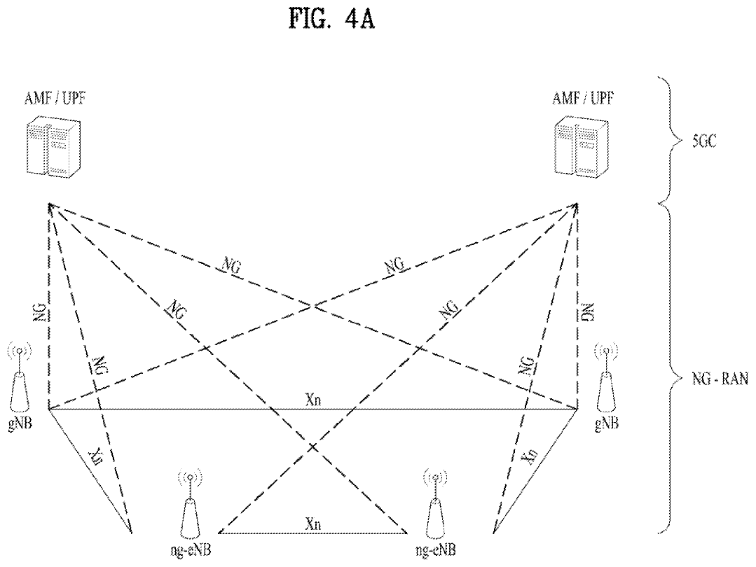

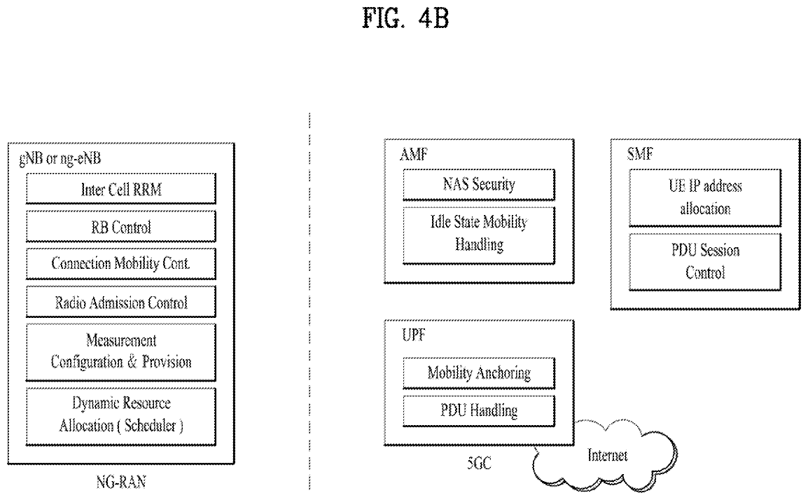

FIG. 4a is a block diagram illustrating network structure of NG Radio Access Network (NG-RAN) architecture, and FIG. 4b is a block diagram depicting architecture of functional Split between NG-RAN and 5G Core Network (5GC).

An NG-RAN node is a gNB, providing NR user plane and control plane protocol terminations towards the UE, or an ng-eNB, providing E-UTRA user plane and control plane protocol terminations towards the UE.

The gNBs and ng-eNBs are interconnected with each other by means of the Xn interface. The gNBs and ng-eNBs are also connected by means of the NG interfaces to the 5GC, more specifically to the AMF (Access and Mobility Management Function) by means of the NG-C interface and to the UPF (User Plane Function) by means of the NG-U interface.

The Xn Interface includes Xn user plane (Xn-U), and Xn control plane (Xn-C). The Xn User plane (Xn-U) interface is defined between two NG-RAN nodes. The transport network layer is built on IP transport and GTP-U is used on top of UDP/IP to carry the user plane PDUs. Xn-U provides non-guaranteed delivery of user plane PDUs and supports the following functions: i) Data forwarding, and ii) Flow control. The Xn control plane interface (Xn-C) is defined between two NG-RAN nodes. The transport network layer is built on SCTP on top of IP. The application layer signalling protocol is referred to as XnAP (Xn Application Protocol). The SCTP layer provides the guaranteed delivery of application layer messages. In the transport IP layer point-to-point transmission is used to deliver the signalling PDUs. The Xn-C interface supports the following functions: i) Xn interface management, ii) UE mobility management, including context transfer and RAN paging, and iii) Dual connectivity.

The NG Interface includes NG User Plane (NG-U) and NG Control Plane (NG-C). The NG user plane interface (NG-U) is defined between the NG-RAN node and the UPF. The transport network layer is built on IP transport and GTP-U is used on top of UDP/IP to carry the user plane PDUs between the NG-RAN node and the UPF. NG-U provides non-guaranteed delivery of user plane PDUs between the NG-RAN node and the UPF.

The NG control plane interface (NG-C) is defined between the NG-RAN node and the AMF. The transport network layer is built on IP transport. For the reliable transport of signalling messages, SCTP is added on top of IP. The application layer signalling protocol is referred to as NGAP (NG Application Protocol). The SCTP layer provides guaranteed delivery of application layer messages. In the transport, IP layer point-to-point transmission is used to deliver the signalling PDUs.

NG-C provides the following functions: i) NG interface management, ii) UE context management, iii) UE mobility management, iv) Configuration Transfer, and v) Warning Message Transmission.

The gNB and ng-eNB host the following functions: i) Functions for Radio Resource Management: Radio Bearer Control, Radio Admission Control, Connection Mobility Control, Dynamic allocation of resources to UEs in both uplink and downlink (scheduling), ii) IP header compression, encryption and integrity protection of data, iii) Selection of an AMF at UE attachment when no routing to an AMF can be determined from the information provided by the UE, iv) Routing of User Plane data towards UPF(s), v) Routing of Control Plane information towards AMF, vi) Connection setup and release, vii) Scheduling and transmission of paging messages (originated from the AMF), viii) Scheduling and transmission of system broadcast information (originated from the AMF or O&M), ix) Measurement and measurement reporting configuration for mobility and scheduling, x) Transport level packet marking in the uplink, xi) Session Management, xii) Support of Network Slicing, and xiii) QoS Flow management and mapping to data radio bearers. The Access and Mobility Management Function (AMF) hosts the following main functions: i) NAS signalling termination, ii) NAS signalling security, iii) AS Security control, iv) Inter CN node signalling for mobility between 3GPP access networks, v) Idle mode UE Reachability (including control and execution of paging retransmission), vi) Registration Area management, vii) Support of intra-system and inter-system mobility, viii) Access Authentication, ix) Mobility management control (subscription and policies), x) Support of Network Slicing, and xi) SMF selection.

The User Plane Function (UPF) hosts the following main functions: i) Anchor point for Intra-/Inter-RAT mobility (when applicable), ii) External PDU session point of interconnect to Data Network, iii) Packet inspection and User plane part of Policy rule enforcement, iv) Traffic usage reporting, v) Uplink classifier to support routing traffic flows to a data network, vi) QoS handling for user plane, e.g. packet filtering, gating, UL/DL rate enforcement, and vii) Uplink Traffic verification (SDF to QoS flow mapping).

The Session Management function (SMF) hosts the following main functions: i) Session Management, ii) UE IP address allocation and management, iii) Selection and control of UP function, iv) Configures traffic steering at UPF to route traffic to proper destination, v) Control part of policy enforcement and QoS, vi) Downlink Data Notification.

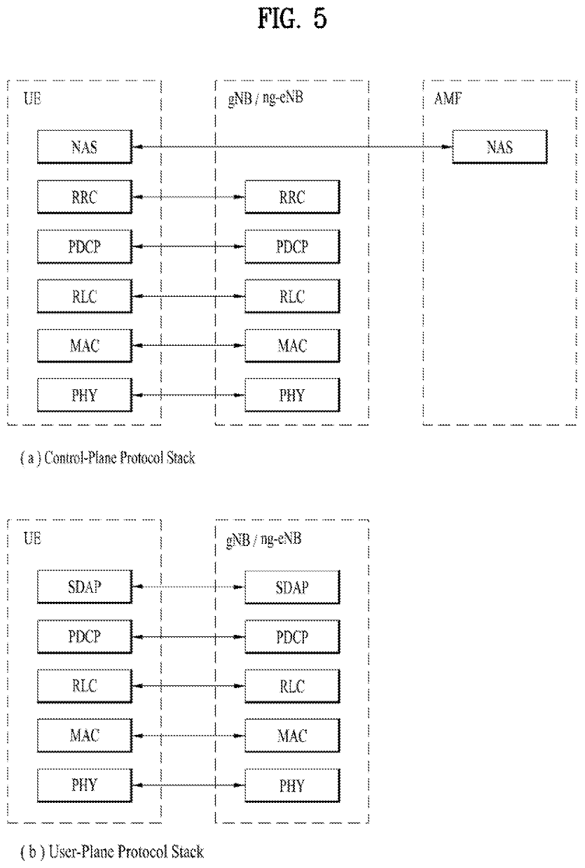

FIG. 5 is a diagram showing a control plane and a user plane of a radio interface protocol between a UE and a NG-RAN based on a 3rd generation partnership project (3GPP) radio access network standard.

The user plane protocol stack contains Phy, MAC, RLC, PDCP and SDAP (Service Data Adaptation Protocol) which is newly introduced to support 5G QoS model.

The main services and functions of SDAP entity include i) Mapping between a QoS flow and a data radio bearer, and ii) Marking QoS flow ID (QFI) in both DL and UL packets. A single protocol entity of SDAP is configured for each individual PDU session.

At the reception of an SDAP SDU from upper layer for a QoS flow, the transmitting SDAP entity may map the SDAP SDU to the default DRB if there is no stored QoS flow to DRB mapping rule for the QoS flow. If there is a stored QoS flow to DRB mapping rule for the QoS flow, the SDAP entity may map the SDAP SDU to the DRB according to the stored QoS flow to DRB mapping rule. And the SDAP entity may construct the SDAP PDU and deliver the constructed SDAP PDU to the lower layers.

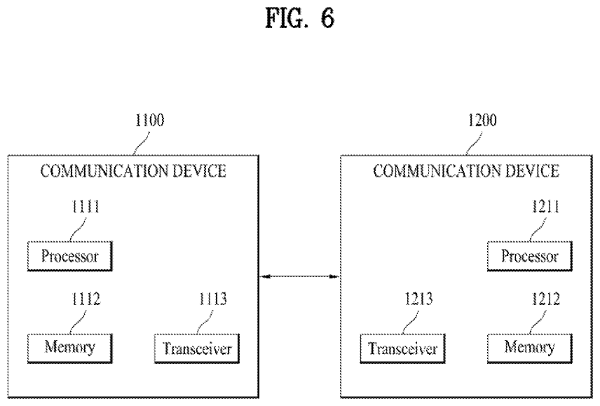

FIG. 6 is a block diagram of communication devices according to an embodiment of the present invention.

The apparatus shown in FIG. 6 can be a user equipment (UE) and/or eNB or gNB adapted to perform the above mechanism, but it can be any device for performing the same operation.

As shown in FIG. 6, one of the communication device 1100 and the communication device 1200 may be a user equipment (UE) and the other one mat be a base station. Alternatively, one of the communication device 1100 and the communication device 1200 may be a UE and the other one may be another UE. Alternatively, one of the communication device 1100 and the communication device 1200 may be a network node and the other one may be another network node. In the present disclosure, the network node may be a base station (BS). In some scenarios, the network node may be a core network device (e.g. a network device with a mobility management function, a network device with a session management function, and etc.).

In some scenarios of the present disclosure, either one of the communication devices 1100, 1200, or each of the communication devices 1100, 1200 may be wireless communication device(s) configured to transmit/receive radio signals to/from an external device, or equipped with a wireless communication module to transmit/receive radio signals to/from an external device. The wireless communication module may be a transceiver. The wireless communication device is not limited to a UE or a BS, and the wireless communication device may be any suitable mobile computing device that is configured to implement one or more implementations of the present disclosure, such as a vehicular communication system or device, a wearable device, a laptop, a smartphone, and so on. A communication device which is mentioned as a UE or BS in the present disclosure may be replaced by any wireless communication device such as a vehicular communication system or device, a wearable device, a laptop, a smartphone, and so on.

In the present disclosure, communication devices 1100, 1200 include processors 1111, 1211 and memories 1112, 1212. The communication devices 1100 may further include transceivers 1113, 1213 or configured to be operatively connected to transceivers 1113, 1213.

The processor 1111 and/or 1211 implements functions, procedures, and/or methods disclosed in the present disclosure. One or more protocols may be implemented by the processor 1111 and/or 1211. For example, the processor 1111 and/or 1211 may implement one or more layers (e.g., functional layers). The processor 1111 and/or 1211 may generate protocol data units (PDUs) and/or service data units (SDUs) according to functions, procedures, and/or methods disclosed in the present disclosure. The processor 1111 and/or 1211 may generate messages or information according to functions, procedures, and/or methods disclosed in the present disclosure. The processor 1111 and/or 1211 may generate signals (e.g. baseband signals) containing PDUs, SDUs, messages or information according to functions, procedures, and/or methods disclosed in the present disclosure and provide the signals to the transceiver 1113 and/or 1213 connected thereto. The processor 1111 and/or 1211 may receive signals (e.g. baseband signals) from the transceiver 1113 and/or 1213 connected thereto and obtain PDUs, SDUs, messages or information according to functions, procedures, and/or methods disclosed in the present disclosure.

The memory of 1112 and/or 1212 is connected to the processor of the network node and stores various types of PDUs, SDUs, messages, information and/or instructions. The memory 1112 and/or 1212 may be arranged inside or outside the processor 1111 and/or 1211, respectively, and may be connected the processor 1111 and/or 1211, respectively, through various techniques, such as wired or wireless connections.

The transceiver 1113 and/or 1213 is connected to the processor 1111 and/or 1211, respectively, and may be controlled by the processor 1111 and/or 1211, respectively, to transmit and/or receive a signal to/from an external device. The processor 1111 and/or 1211 may control transceiver 1113 and/or 1213, respectively, to initiate communication and to transmit or receive signals including various types of information or data which are transmitted or received through a wired interface or wireless interface. The transceivers 1113, 1213 include a receiver to receive signals from an external device and transmit signals to an external device.

In a wireless communication device such as a UE or BS, an antenna facilitates the transmission and reception of radio signals (i.e. wireless signals). In the wireless communication device, the transceiver 1113 or 1213 transmits and/or receives a wireless signal such as a radio frequency (RF) signal. For a communication device which is a wireless communication device (e.g. BS or UE), the transceiver 1113 or 1213 may be referred to as a radio frequency (RF) unit. In some implementations, the transceiver 1113 and/or 1213 may forward and convert baseband signals provided by the processor 1111 and/or 1211 connected thereto into radio signals with a radio frequency. In the wireless communication device, the transceiver 1113 or 1213 may transmit or receive radio signals containing PDUs, SDUs, messages or information according to functions, procedures, and/or methods disclosed in the present disclosure via a radio interface (e.g. time/frequency resources). In some implementations, upon receiving radio signals with a radio frequency from another communication device, the transceiver 1113 and/or 1213 may forward and convert the radio signals to baseband signals for processing by the processor 1111 and/or 1211. The radio frequency may be referred to as a carrier frequency. In a UE, the processed signals may be processed according to various techniques, such as being transformed into audible or readable information to be output via a speaker of the UE.

In some scenarios of the present disclosure, functions, procedures, and/or methods disclosed in the present disclosure may be implemented by a processing chip. The processing chip may be a system on chip (SoC). The processing chip may include the processor 1111 or 1211 and the memory 1112 or 1212, and may be mounted on, installed on, or connected to the communication device 1100 or 1200. The processing chip may be configured to perform or control any one of the methods and/or processes described herein and/or to cause such methods and/or processes to be performed by a communication device which the processing chip is mounted on, installed on, or connected to. The memory 1112 or 1212 in the processing chip may be configured to store software codes including instructions that, when executed by the processor, causes the processor to perform some or all of functions, methods or processes discussed in the present disclosure. The memory 1112 or 1212 in the processing chip may store or buffer information or data generated by the processor of the processing chip or information recovered or obtained by the processor of the processing chip. One or more processes involving transmission or reception of the information or data may be performed by the processor 1111 or 1211 of the processing chip or under control of the processor 1111 or 1211 of the processing chip. For example, a transceiver 1113 or 1213 operably connected or coupled to the processing chip may transmit or receive signals containing the information or data under the control of the processor 1111 or 1211 of the processing chip.

For a communication device which is a wireless communication device (e.g. BS or UE), the communication device may include or be equipped with a single antenna or multiple antennas. The antenna may be configured to transmit and/or receive a wireless signal to/from another wireless communication device.

For a communication device which is a UE, the communication device may further include or be equipped with a power management module, an antenna, a battery, a display, a keypad, a Global Positioning System (GPS) chip, a sensor, a memory device, a Subscriber Identification Module (SIM) card (which may be optional), a speaker and/or a microphone. The UE may include or be equipped with a single antenna or multiple antennas. A user may enter various types of information (e.g., instructional information such as a telephone number), by various techniques, such as by pushing buttons of the keypad or by voice activation using the microphone. The processor of the UE receives and processes the user's information and performs the appropriate function(s), such as dialing the telephone number. In some scenarios, data (e.g., operational data) may be retrieved from the SIM card or the memory device to perform the function(s). In some scenarios, the processor of the UE may receive and process GPS information from a GPS chip to perform functions related to a position or a location of a UE, such as vehicle navigation, a map service, and so on. In some scenarios, the processor may display these various types of information and data on the display for the user's reference and convenience. In some implementations, a sensor may be coupled to the processor of the UE. The sensor may include one or more sensing devices configured to detect various types of information including, but not limited to, speed, acceleration, light, vibration, proximity, location, image and so on. The processor of the UE may receive and process sensor information obtained from the sensor and may perform various types of functions, such as collision avoidance, autonomous driving and so on. Various components (e.g., a camera, a Universal Serial Bus (USB) port, etc.) may be further included in the UE. For example, a camera may be further coupled to the processor of the UE and may be used for various services such as autonomous driving, a vehicle safety service and so on. In some scenarios, some components, e.g., a keypad, a Global Positioning System (GPS) chip, a sensor, a speaker and/or a microphone, may not be implemented in a UE.

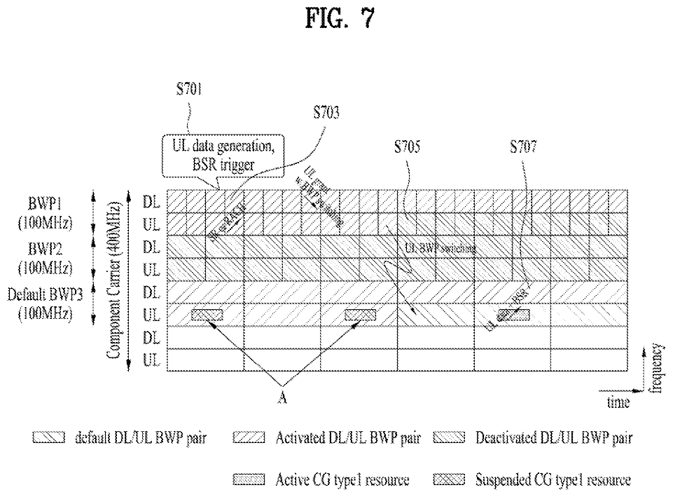

FIG. 7 is an example for Bandwidth Part (BWP) operation in the prior art.

In NR, the maximum channel bandwidth can be 400 MHz per carrier. Operating the wider bandwidth on a single carrier is more efficient than aggregating contiguous intra-band CCs with smaller bandwidth. In order to provide the carrier with maximum bandwidth for UEs with different RF chain capabilities, RAN1 agreed to support the aggregation of multiple sub-bands with smaller bandwidth. In this wider bandwidth operation, it assumes that one or multiple bandwidth part (BWP) configurations for each CC can be semi-statically signalled to a UE and each bandwidth part is associated with a specific numerology.

Based on the current agreement, the DL/UL BWP can be defined as follows:
Initial active DL/UL BWP: it is valid for a UE until the UE is explicitly (re)configured with bandwidth part(s) during or after RRC connection is established. As the first RRC Connection reconfiguration can be received only after the UE completes the RRC Connection establishment, it could be understood that BWP switching doesn't occur during RA procedure for RRC Connection establishment.
Default DL/UL BWP: For a Pcell, the default DL BWP (or DL/UL BWP pair) can be configured/reconfigured to a UE. If no default DL BWP is configured, the default DL BWP is the initial active DL BWP. For an Scell, the default DL BWP (or DL/UL BWP pair) can be configured to a UE with a timer for timer-based active DL BWP (or DL/UL BWP pair) switching, along with a default DL BWP (or the default DL/UL BWP pair) which is used when the timer is expired. The default DL BWP for a Scell can be different from the first active DL BWP.
Active DL/UL BWP other than the default DL/UL BWP: One or multiple DL BWP(s) and UL BWP(s) (or DL/UL BWP pair(s)) can be semi-statically configured to a UE by signalling. UE expects at least one DL BWP and one UL BWP being active among the set of configured BWPs for a given time instant. A UE is only assumed to receive/transmit within active DL/UL bandwidth part(s) using the associated numerology.
DL/UL BWP pair: For unpaired spectrum, a DL BWP and an UL BWP are jointly configured as a pair, with the restriction that the DL and UL BWPs of such a DL/UL BWP pair share the same centre frequency but may be of different bandwidths in Rel-15 for each UE-specific serving cell for a UE. For paired spectrum, DL and UL BWPs are configured separately and independently in Rel-15 for each UE-specific serving cell for a UE. Up to now, there was no discussion whether the paired DL/UL BWP is configured with cell-common manner or UE-specific manner. Based on the agreement, it seems that a DL BWP and an UL BWP can be jointly configured as a pair in the UE-specific manner for unpaired spectrum.

The activation/deactivation of DL and UL BWPs can be performed by means of dedicated RRC signalling, DCI or timer. Timer-based switching is to support a fallback mechanism to default DL BWP. In this case, a UE starts the timer when switching to a DL BWP other than the default DL BWP and restarts the timer to the initial value when it successfully decodes a DCI to schedule PDSCH(s) in its active DL BWP. And, the UE switches its active DL BWP to the default DL BWP when the BWP inactivity timer expires. If the active DL/UL BWP has been paired, a UE will switch to default DL/UL BWP pair when the switching condition is met.

For UL SPS, RAN2 agreed to use Configured Grant (CG) Type 1 and Configured Grant (CG) Type 2. CG Type 1 resource is activated upon RRC configuration according to resource allocation in terms of periodicity and offset provided within the configuration, and it is released by RRC. The MAC entity shall clear the configured uplink resource assignments for CG type 1 immediately when receiving RRC reconfiguration message of CG Type 1 release. However, the CG type 1 resource of the deactivated BWP/SCcell is suspended when the BWP or ScCell is deactivated. From the MAC point of view, the suspended CG type 1 resource is not deactivated (i.e., not clear), but is considered as invalid resource due to the deactive BWP/ScCell. Upon SceCll/BWP activation the UE starts using the CG type 1 resources of the active ScCell/BWP.

In NR, the MAC entity may be configured with zero, one, or more SR configurations. Each SR configuration corresponds to one or more logical channels. If UE have SR configurations but a mapping is not configured for a LCH assigned to a LCG, a RACH is triggered.

Currently, the UE cannot switch itself to another UL BWP without explicit/implicit indication of the gNB or timer expiry, except for switching to the initial DL/UL BWP for CBRA. Moreover, the UE cannot activate itself the ScCell without explicit signalling of the gNB.

For example, as shown the FIG. 7, when uplink data to be transmitted is generated, the UE should trigger a BSR (S701). If there is no uplink resource to be transmitted the uplink data, the UE should transmits a SR or initiates a RACH procedure (S703) even though the UE has suspended CG type1 resources on the deactive BWP (A point). When the UE switches the inactive BWP having the suspended CG type1 resources due to timer expiry or DCI command (S705), the UE can use the suspended CG type1 resources after the suspended CG type1 resources are activated (S707).

If the UE can use the suspended CG type 1 resource of the inactive BWP, the UE may not need to trigger SR or RACH requesting UL resource. In particular, if SR or RACH is triggered for a URLLC data and the suspended CG type 1 resource has been allowed to transmit the URLLC data, it seems very inefficient to request the UL resource only through RACH or SR. Using suspended/configured UL resources may be better than requesting UL resources.

So, NR is necessary to reflect that a UE can switch to (or activates) the UL BWP or SCell with the configured UL resources if there is no available UL resources on the active BWP or SCell, in order for a UE to use the configured UL resources, e.g., PUSCH, PUCCH, etc., on the inactive UL BWP/SCell.

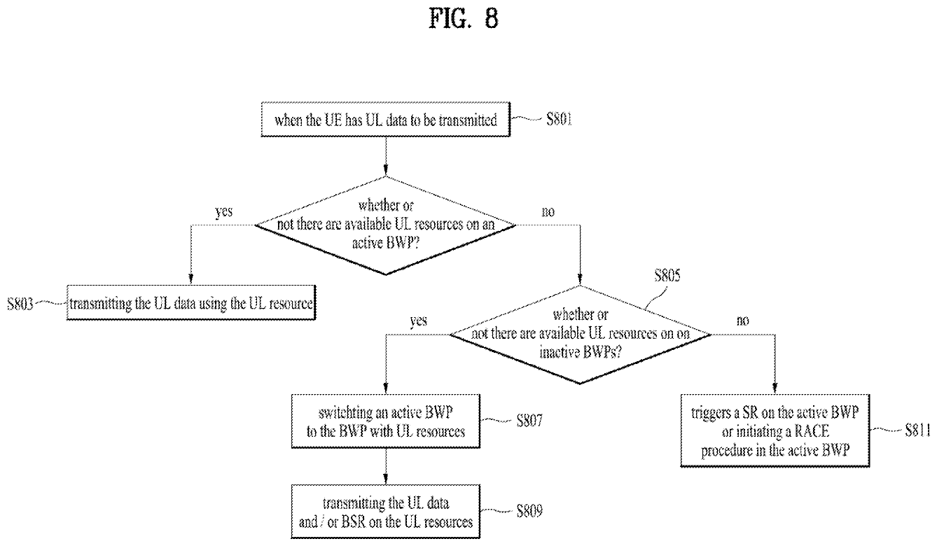

FIG. 8 is a conceptual diagram for switching a Bandwidth part (BWP) for configured UL resources by a user equipment in wireless communication system according to embodiments of the present invention.

This embodiment describes from a user equipment perspective.

This invention proposes that when BSR is triggered and there is no available UL uplink resource on the active UL BWP, the UE switches to (or activates) the UL BWP with a configured UL resource without initiating a RA procedure or a SR transmission.

When the UE has UL data to be transmitted, the UE checks whether or not there are available uplink (UL) resources on an active UL Bandwidth Part (BWP) (S801).

Preferably, the available UL resources may be UL resources allowed to transmit the new data or Buffer Status Reporting (BSR), or may be Scheduling Request (SR) PUCCH resources configured to request the UL resource for new data.

Preferably, the configured UL resource may be configured grant resources, i.e., suspended CG type1 or type2 resource on the inactive UL BWP, or may be configured SR PUCCH resources on the inactive UL BWP.

If there is available UL resource to transmit the UL data in the active UL BWP, the UE may transmit the UL data using the UL resource (S803).

Else if there is no available UL resource to transmit the UL data in the active UL BWP, the UE further checks whether or not there are UL resources on inactive UL BWPs before initiating a RA procedure or a SR transmission (S805).

The scheme 1 proposes that if the UE doesn't have a configured resource on the active UL BWP, the UE checks whether or not there are suspended CG resources on the inactive UL BWP.

The scheme 2 proposes that when SR is triggered and there is no valid SR PUCCH resource configured for the active UL BWP, the UE checks whether or not there are configured SR PUCCH resources allowed to request UL resource for the new data on the inactive UL BWP.

According to the scheme 1, if there are suspended CG resources in one of the inactive BWPs, the UE switches to (or activates) the UL BWP with a suspended CG resource (S807), resumes the suspended CG resource, and transmits the new data and/or BSR on the configured resource on the switched UL BWP (S809).

In a case that there is only one active BWP in the UE, when the UE activates the UL BWP with the suspended CG resource, the UE deactivates an already active UL BWP, autonomously.

In a case that there are multiple active BWPs in the UE, when the UE activates the UL BWP with the suspended CG resource, the UE keeps the already active UL BWP. That is, the UE doesn't deactivate the already active UL BWP, autonomously.

If there are more than one BWPs with suspended CG resources for a UE, the UE can select one UL BWP among them.

If there are more than one UL BWPs with suspended CG resources for a UE and there is available CG resources allowed to transmit the new data, the UE selects a UL BWP with the suspended CG resource allowed to transmit the new data.

If there are more than one UL BWPs with suspended CG resources for a UE and there is no available CG resource allowed to transmit the new data, the UE selects a UL BWP with the suspended CG resource allowed to transmit a BSR.

If the UE doesn't have any suspended CG resource in all of the configured UL BWPs, the UE triggers a SR on the active UL BWP or initiates a Random Access (RA) procedure on the active UL BWP (S811).

If more than one UL BWPs are selected, the UE can select a UL BWP with the earliest CG resource among the UL BWPs.

According to the scheme 2, if there are configured SR PUCCH resources, the UE switches to (or activates) the UL BWP with a configured SR PUCCH resource, and instructs the physical layer to signal the SR on one valid PUCCH resource for SR on the new UL BWP.

In a case that there is only one active BWP in the UE, when the UE activates the UL BWP with the configured SR PUCCH resources, the UE deactivates an already active UL BWP, autonomously.

In a case that there are multiple active BWPs in the UE, when the UE activates the UL BWP with the configured SR PUCCH resources, the UE keeps the already active UL BWP. That is, the UE doesn't deactivate the already active UL BWP, autonomously.

If there are more than one BWPs with SR PUCCH resource which is available for the new data, the UE switches to the UL BWP with the earliest SR PUCCH resource among the UL BWPs.

Preferably, this invention is preferably applied where DL and UL BWPs are configured separately and independently for each UE-specific serving cell for a UE. But, it is not limited to thereto, if available.

For example, if the active DL/UL BWP has been paired (i.e. unpaired spectrum), a DL BWP and an UL BWP are jointly configured as a pair, with the restriction that the DL and UL BWPs of such a DL/UL BWP pair share the same centre frequency but may be of different bandwidths in Rel-15 for each UE-specific serving cell for a UE. Based on the agreement, it seems that a DL BWP and an UL BWP can be jointly configured as a pair in the UE-specific manner for unpaired spectrum. Thus, when the UE switches an active UL BWP due to transmission data or BSR, the UE can switches an active DL BWP of the serving cell to a default/initial DL BWP.

Meanwhile, for paired spectrum, DL and UL BWPs are configured separately and independently in Rel-15 for each UE-specific serving cell for a UE. So, in this case where a DL BWP and a UL BWP are separately configured, when the UE switches to the initial DL BWP if there is no available UL resource to transmit the UL data in the active UL BWP, the UE can switch to initial DL BWP optionally. In this case, the active DL BWP is switched when a switching command for the active DL BWP is received or timer is expired regardless of the switching for the UL BWP.

This invention is preferably applied for SCell of Carrier Aggregation (CA) operation as well as BWP of Wide-Bandwidth operation.

As shown in FIG. 6, the UE (1100 or 1200) may comprises processor (1111 or 1211), Memory (1112 or 1212) and RF module (transceiver; 1113 or 1213). The processor (1111 or 1211) is electrically connected with the transceiver (1113 or 1213) and controls it.

Specifically, FIG. 6 may represent a UE comprising a processor (1111 or 1211) operably coupled with a memory (1112 or 1212) and configured to check whether or not there are available uplink (UL) resources on an active UL Bandwidth Part (BWP), when there is UL data to be transmitted; check whether or not there are UL resources on inactive UL BWPs, if there is no available UL resource to transmit the UL data in the active UL BWP; select a UL BWP among the inactive UL BWPs which have UL resources allowed to transmit the UL data; switch an active UL BWP to the selected UL BWP, and transmit the UL data using the UL resource on the selected UL BWP.

The proposed method is implemented by may be implemented by a processing chip. In case of a system on chip (SoC), the processing chip may include the processor 1111 or 1211 and the memory 1112 or 1212, and may be mounted on, installed on, or connected to the communication device 1100 or 1200.

The processing chip may be configured to check whether or not there are available uplink (UL) resources on an active Bandwidth Part (BWP), when there is UL data to be transmitted; check whether or not there are UL resources on inactive UL BWPs, if there is no available UL resource to transmit the UL data in the active UL BWP; select a UL BWP among the inactive UL BWPs which have UL resources allowed to transmit the UL data; switch an active UL BWP to the selected UL BWP, and transmit the UL data using the UL resource on the selected UL BWP.

The memory 1112 or 1212 in the processing chip may be configured to store software codes including instructions that, when executed by the processor, causes the processor to perform some or all of functions, methods or processes discussed in the present disclosure.

The transceiver 1113 or 1213 is operably connected or coupled to the processing chip.

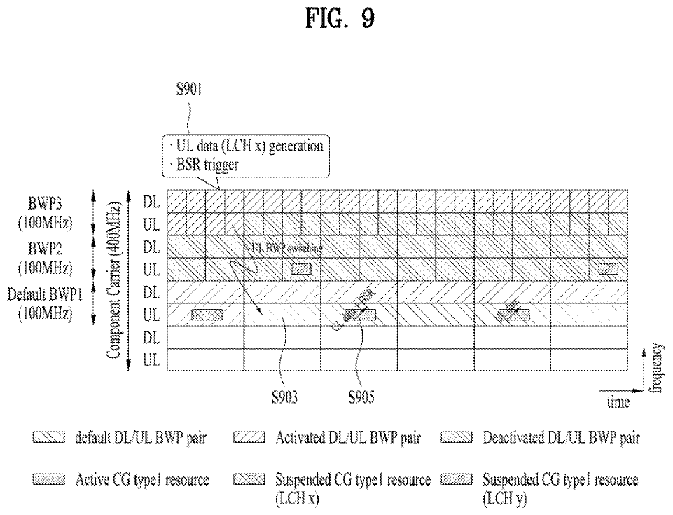

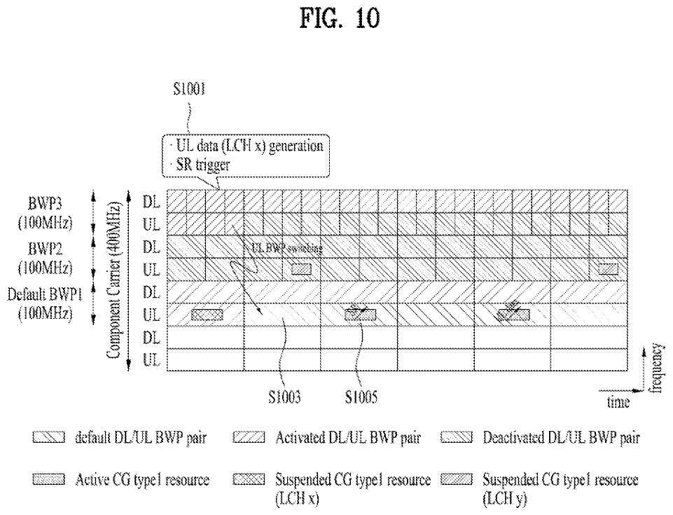

FIGS. 9 and 10 are examples for switching a Bandwidth part (BWP) for configured UL resources in wireless communication system according to embodiments of the present invention.

The FIG. 9 describes the exemplary behavior of the UE in the scheme1 of this invention.

The example assumes the followings: i) for a wider bandwidth cell, 3 BWPs are configured to the UE (i.e., default BWP1, BWP2, BWP3), ii) CG type 1 resources for the LCH x and LCH y have been suspended on the inactive BWP1 and BWP2, respectively, and iii) BWP3 is active.

As shown FIG. 9, when the UE generates new UL data for LCH x, the UE triggers a BSR (S901).

The UE checks whether or not there are available UL resources on the active BWP.

If there is no available UL resource to transmit the new data or BSR, the UE checks whether or not there are suspended CG type1 resources on the inactive BWP.

If there are suspended CG Type1 resources on inactive BWPs, the UE selects one BWP with suspended CG Type1 resource allowed to transmit the new data or BSR.

The UE switches to the selected BWP1 (S903), and the UE can deactivate the BWP3 and UE resumes the suspended CG type1 on the BWP1 without additional signaling.

And then the UE transmits the new data and/or BSR on the CG type1 resource of the BWP1 (S905).

If there is no suspended CG Type1 resources on inactive BWPs, the UE triggers a Scheduling Request.

The FIG. 10 describes the exemplary behavior of the UE in the scheme2 of this invention.

The example assumes the followings: i) for a wider bandwidth cell, 3 BWPs are configured to the UE (i.e., default BWP1, BWP2, BWP3), ii) the SR PUCCH resources for the LCH x and LCH y have been configured on the inactive BWP1 and BWP2, respectively, and iii) BWP3 is active.

As shown FIG. 10, when the UE generates new UL data for LCH x, the UE triggers a SR (S1001).

The UE checks whether or not there are available SR PUCCH resources on the active BWP.

If there is no available SR PUCCH resource to request UL resource for the new data of LCH x, the UE checks whether or not there are configured SR PUCCH resources allowed for LCH x on the inactive BWP.

If there are configured SR PUCCH resources on inactive BWPs, the UE selects one BWP with configured SR PUCCH resource allowed for LCH x.

The UE switches to the selected BWP1 and the UE can deactivate the BWP3 (S1003).

The UE transmits the SR on one valid PUCCH resource for SR on the BWP1 (S1005)

If there is no configured SR PUCCH resource on inactive BWPs, the UE triggers a Random Access procedure.

The aforementioned implementations are achieved by combination of structural elements and features of the present disclosure in a predetermined manner. Each of the structural elements or features should be considered selectively unless specified separately. Each of the structural elements or features may be carried out without being combined with other structural elements or features. In addition, some structural elements and/or features may be combined with one another to constitute the implementations of the present disclosure. The order of operations described in the implementations of the present disclosure may be changed. Some structural elements or features of one implementation may be included in another implementation, or may be replaced with corresponding structural elements or features of another implementation. Moreover, it is apparent that some claims referring to specific claims may be combined with another claims referring to the other claims other than the specific claims to constitute the implementation or add new claims by amendment after the application is filed.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors, etc.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE and NR system, the present invention is applicable to a variety of wireless communication systems in addition to the 3GPP LTE and NR system.

1. A method for a User Equipment (UE) operating in a wireless communication system, the method comprising:
checking whether or not there are available uplink (UL) resources on a first UL Bandwidth Part (BWP), based on the UE having UL data to be transmitted, wherein the first UL BWP is an active BWP;
checking whether or not there are UL resources on inactive UL BWPs, based on there being no available UL resource to transmit the UL data in the first UL BWP;
selecting a UL BWP among the inactive UL BWPs which have UL resources allowed to transmit the UL data;
activating the selected UL BWP; and
transmitting the UL data using the UL resource on the selected UL BWP.

2. The method according to claim 1, wherein based on the selected UL BWP being activated, the UL resources on the selected UL BWP are activated to enable transmission of the UL data.

3. The method according to claim 1, wherein based on the selected UL BWP being activated, the first UL BWP is deactivated.

4. The method according to claim 1, wherein the UL data includes user data or information for buffer status reporting (BSR).

5. The method according to claim 1, wherein the UL resource is a configured grant.

6. The method according to claim 1, wherein based on there being no available UL resource to transmit the UL data in all configured UL BWPs, the UE initiates a Random Access (RA) procedure.

7. The method according to claim 4, wherein based on there being available UL resources allowed to transmit user data, the UE selects a UL BWP with the suspended UL resource allowed to transmit the user data, and
based on there being no available UL resources allowed to transmit user data, the UE selects a BWP with the suspended UL resource allowed to transmit a buffer status reporting.

8. A communication device for operating in a wireless communication system, the communication device comprising:
a memory; and
a processor operably coupled with the memory and configured to:
check whether or not there are available uplink (UL) resources on active first UL Bandwidth Part (BWP), based on there being UL data to be transmitted, wherein the first UL BWP is an active BWP;
check whether or not there are UL resources on inactive UL BWPs, based on there being no available UL resource to transmit the UL data in the first UL BWP;
select an UL BWP among the inactive UL BWPs which have UL resources allowed to transmit the UL data;
activating the selected UL BWP, and
transmit the UL data using the UL resource on the selected UL BWP.

9. The communication device according to claim 8, wherein based on the selected UL BWP being activated, the UL resources on the selected UL BWP are activated to enable transmission of the UL data.

10. The communication device according to claim 8, wherein based on the selected UL BWP being activated, the first UL BWP is deactivated.

11. The communication device according to claim 8, wherein the UL data includes user data or information for buffer status reporting (BSR).

12. The communication device according to claim 8, wherein the UL resource is a configured grant.

13. The communication device according to claim 8, based on there being no available UL resource to transmit the UL data in all configured UL BWPs, the processor initiates a Random Access (RA) procedure.
